(19) United States
(12) Patent Application Publication
(10) Pub. No.: US 2009/0061369 A1
(43) Pub. Date: Mar. 5, 2009

(54) Multi-response time burner system for controlling combustion driven pulsation

(75) Inventors: Dexin Wang, Indian Creek, IL (US); David F. Cygan, Villa Park, IL (US); Richard A. Knight, Brookfield, IL (US)

Correspondence Address: MARK E. FEJER;GAS TECHNOLOGY INSTITUTE, 1700 SOUTH MOUNT PROSPECT ROAD, DES PLAINES, IL, 60018, US

(73) Assignee: GAS TECHNOLOGY INSTITUTE, Des Plaines, IL (US)

(21) Appl. No.: 11/895,890

(22) Filed: Aug. 28, 2007

(51) Int. Cl. F23M 13/00; F02C 7/24; F23R 3/28

(52) U.S. Cl. 431/114; 60/737

(57) ABSTRACT

A combustion system having at least one wall enclosing a combustion chamber and forming a plurality of burner or burner nozzle openings. Disposed within each of the openings is a premix burner or burner nozzle, each of which has a premixed fuel/oxidant outlet proximate the combustion chamber and a fuel/oxidant inlet distal from the combustion chamber. At least a portion of the premix burners or burner nozzles are sized to produce different fuel/oxidant delivery disturbance response times in response to a pressure disturbance within the combustion system. Differences in fuel/oxidant delivery response times are achieved by using burners or burner nozzles having different internal dimensions, different volume flow rates, and, optionally, by varying the fuel/oxidant ratios of the mixtures flowing through the burners or burner nozzles.

### BACKGROUND OF THE INVENTION

1. Field of the Invention

This invention relates to a combustion system and method for reducing or eliminating combustion driven acoustic pulsations that occur in industrial combustion systems employing premix or partial premix industrial burners. More particularly, this invention relates to premix or partial premix burners or burner systems for use in boilers, process heaters and the like which reduce or eliminate combustion driven acoustic pulsations normally generated by conventional premix or partial premix burners or burner systems.

2. Description of Related Art

Conventional premix or partial premix burners utilized, for example, in boilers, are inherently subject to combustion instability in the combustion chamber as represented by dynamic pressure oscillations in the combustion chamber. These pressure oscillations, which may occur at various fundamental or predominant resonant frequencies and other higher order harmonic, are capable of generating unacceptable amounts of acoustic noise.

For most industrial burners, fuel and oxidant, the latter typically being air, are typically available at different pressures. Fuel pressures are frequently greater than 5 pounds per square inch (psi) whereas air pressures are usually less than about 1 psi and often less than about 20 inches of water column. As a result, whenever a pressure disturbance occurs in the combustion chamber of a combustion system, the air flow to a given burner of a multi-burner combustion system or to a given nozzle of a multi-nozzle burner can be significantly affected, whereas the corresponding effect to the fuel flow may be minimal. The result may be a dramatic change in the fuel/air ratio which, in turn, will affect the heat release pattern in the combustion chamber and, in some instances, may even cause flame blowout when the fuel-rich limit is reached.

Most multi-firing nozzle premix burners and multi-burner combustion systems are designed with a single fuel/air delivery response time which provides a substantially uniform response time to a pressure disturbance in the combustion chamber for all of the burner nozzles or burners. Heat release peaks in these conventional burner systems from all firing burners or firing nozzles occur at substantially the same time inside the combustion chamber whenever there is a pressure disturbance affecting the fuel/air delivery rate or ratio. When this heat release frequency matches one of the natural frequencies of the combustion chamber, according to Rayleigh criteria, acoustic resonance will occur due to the heat release oscillation being in phase with one of the natural frequencies of the combustion system. This is referred to as combustion pulsation. Combustion pulsation, in addition to the unacceptable acoustic noise generated that is harmful to human health, is undesirable because it can dramatically affect the burner performance and cause combustion system structural damage.

It is known that such combustion pulsations may be reduced by the application of asymmetry in the heat release or by axially distributing or spreading out the heat release. One known method for producing the asymmetry to reduce the combustion pulsations is to bias fuel to one or more burners, generating more local heat release. An alternative method involves distributing the flame axially by physically offsetting one or more fuel injectors within the combustion chamber. U.S. Pat. No. 6,269,646 B1 teaches a combustion system employing pre-mixers for reducing combustion pulsations in which a portion of the pre-mixers comprise an altered flameholding capability so as to distribute the resulting combustion flames from the respective portion of the pre-mixers axially downstream with respect to the non-altered pre-mixers, thereby reducing the dynamic pressure amplitude of the combustion flames.

### SUMMARY OF THE INVENTION

It is, thus, one object of this invention to provide a method and combustion system for substantially reducing combustion driven pulsations in a combustion chamber.

It is another object of this invention to provide a method and combustion system for reducing noise generated by combustion systems employing premix or partial premix burners and burner nozzles.

These and other objects of this invention are addressed by a combustion system comprising at least one wall enclosing a combustion chamber and forming a plurality of burner nozzle openings, and a premix burner nozzle, i.e. a burner nozzle suitable for premixing or partial premixing of a fuel and an oxidant, disposed within each of the burner nozzle openings, where each premix burner nozzle has a premixed fuel/oxidant outlet proximate the combustion chamber and a fuel/oxidant inlet distal from the combustion chamber, and at least a portion of the premix burner nozzles are sized to produce different fuel/oxidant delivery response times. We have discovered that if the premix burner nozzles are designed such that at least one or more burner nozzles has significantly different internal dimensions than the internal dimensions of other premix burner nozzles of the combustion system, a longer amount of time will be required for the unaffected fuel/oxidant mixtures to be exhausted from the burner nozzles having larger internal dimensions, e.g. volumes, than from the burner nozzles having smaller internal dimensions. As a result, the burner nozzles having larger internal dimensions respond to a pressure disturbance within the combustion chamber affecting the fuel/oxidant ratio slower than the burner nozzles having smaller internal dimensions, resulting in time lags between the heat release peaks arriving at the combustion chamber. That is, by dividing a single large group of burner nozzles having the same fuel/oxidant delivery response time into several nozzles having different fuel/oxidant delivery response times, the single large heat release peak or pulsation normally produced by the single large group of burner nozzles is divided into several smaller heat release peaks or pulsations with phase shifts. Thus, the heat release pulsation represented by the combination of the smaller heat release pulsations has a much smaller amplitude than the single large heat release pulsation and the smaller heat release pulsations may cancel each other out as a result of the lags in response times between each group of burners or burner nozzles, i.e. phase differences.

In accordance with the method of this invention, a burner nozzle is positioned in each of a plurality of burner nozzle openings formed by at least one wall of a combustion chamber with at least a portion of the burner nozzles having internal dimensions different from others of the burner nozzles. A fuel and oxidant are premixed by introduction into each of the burner nozzles, resulting in a fuel/oxidant mixture within the burner nozzles. The fuel/oxidant mixtures are ignited, resulting in combustion of the fuel/oxidant mixtures and producing a plurality of heat release patterns with phase shift within the combustion chamber. Phase shift refers to the relative axial locations of the heat release pulsations within the combustion chamber. Thus, while one of the burner nozzles may produce a heat release pulsation which matches one of the natural frequencies of the combustion chamber, the other nozzles will have heat release pulsations which most probably do not match the natural frequencies of the combustion chamber, thereby reducing the potential for generation of unacceptable acoustic pulsations.

### BRIEF DESCRIPTION OF THE DRAWINGS

These and other objects and features of this invention will be better understood from the following detailed description taken in conjunction with the drawings wherein:

FIG. 1 is a schematic diagram of a conventional combustion system illustrating the generation of combustion-driven pulsation within a combustion chamber;

FIG. 2 is a schematic diagram of a burner in accordance with one embodiment of this invention illustrating the principle of substantially reducing or eliminating combustion-driven pulsation in accordance with the method of this invention; and

FIG. 3 is a schematic diagram of a combustion system with a plurality of burners for combustion driven pulse control in accordance with one embodiment of this invention.

### DETAILED DESCRIPTION OF THE PRESENTLY PREFERRED EMBODIMENTS

As used herein, the term “delivery response time” refers to the period of time extending from the occurrence of a pressure disturbance within a combustion chamber to the point in time at which the altered fuel/oxidant mixture, having been altered by the pressure disturbance, is ignited in the combustion chamber. As used herein, the term “disturbance response time” is interchangeable with the delivery response time.

The disturbance response time T of a burner nozzle is calculated as

T=T₁+T₂+T₃

where T₁ is the time for a pressure disturbance in the combustion system to travel at the speed of sound to the nozzle fuel/air inlet to affect the fuel and air flow; T₂ is the time for the fuel/air mixture to travel from the nozzle inlet to its outlet, i.e.

T₂=Vol/Q

where Vol is the interior volume of the burner nozzle and Q is the volume flow rate through the corresponding burner nozzle. T₃ is the time period from the fuel/air mixture exiting from the nozzle tip to the onset of the flame. Typically, T₂ is much longer than T₁ and T₃, and T₁ and T₃ are nearly constant for a certain combustion system and not easy to change. Thus, changing T₂ is the easiest and most effective way to change the disturbance response time. That is, burner nozzle disturbance response time can be modified by changing Vol and/or Q.

The fundamental concept of this invention is the use of multi-response time premix or partial premix burners or burner nozzles to reduce or eliminate combustion driven acoustic pulsations. The basic idea is to provide a combustion system comprising a plurality of burners or burner nozzles having significantly different fuel/oxidant delivery response times. This may be achieved with burner nozzles having different internal dimensions, preferably by at least about 25%, e.g. different mixing chamber volumes which create different volumes of unaffected buffer mixtures, different fuel/oxidant mixture flow rates through the burner nozzles, or both. It will be understood that, as used herein, the term “oxidant” refers to air, oxygen, and oxygen-enriched air. By arranging the burner nozzles in this manner whenever there is a pressure disturbance occurring within the combustion chamber of the combustion system, the different burner nozzles having different internal dimensions will respond to the disturbance at different times, which, in turn, will create response time lags between the burner nozzles so that the final affected fuel/oxidant mixtures arrive at the combustion chamber with delay times relative to each other. Accordingly, the conventional single high heat release peak or pulse produced by conventional systems is split into multiple, non-reinforcing peaks or pulses, which may also cancel each other out if the time lags are properly timed. The reduced amplitude of the heat release pulsations will input less energy in phase with the acoustic oscillation so that sustained combustion pulsation may be eliminated.

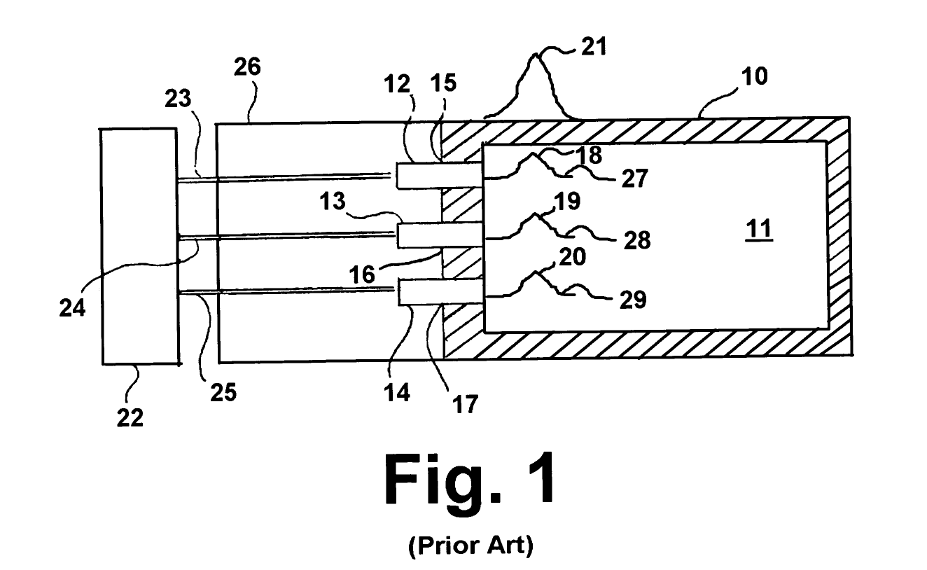

As previously stated, conventional premix and partial premix industrial and commercial burner systems having a plurality of burners or burner nozzles are designed so as to produce a single fuel/air delivery response time, which design provides a substantially uniform response time to a disturbance, such as a pressure disturbance, within the combustion system. FIG. 1 schematically illustrates the scenario for a conventional premix system. As shown therein, the combustion system comprises a combustion chamber wall 10 enclosing a combustion chamber or space 11 and forming a plurality of burner nozzle openings 15, 16, and 17. Disposed within each burner nozzle opening is a corresponding burner nozzle 12, 13, and 14, respectively, each of which has substantially the same internal dimensions, i.e. length and diameter. The burner nozzle fuel/oxidant inlet ends are disposed within an oxidant-containing plenum 26 from which oxidant, typically air, is provided to the burner nozzles. Fuel is provided to the burner nozzles by means of fuel conduits 23, 24, and 25, which are connected with and in fluid communication with a fuel-containing plenum 22. Depending upon the fuel injection means employed, for example, radial injection, the fuel conduits may extend into the interior of the burner nozzles. Upon the occurrence of a pressure disturbance in combustion chamber 11, as previously indicated, the oxidant flow to the burner nozzles changes, resulting in a change in the fuel/oxidant ratio, which, in turn, results in a substantially uniform change 18, 19, 20 in the heat release patterns 27, 28, 29 in the combustion chamber. Because the burner nozzles have the same internal dimensions, the time required for the changes to reach the combustion chamber is the same for each burner nozzle, which will create a large combined heat release peak as represented by peak 21 which may match one of the natural resonant frequencies of the combustion system.

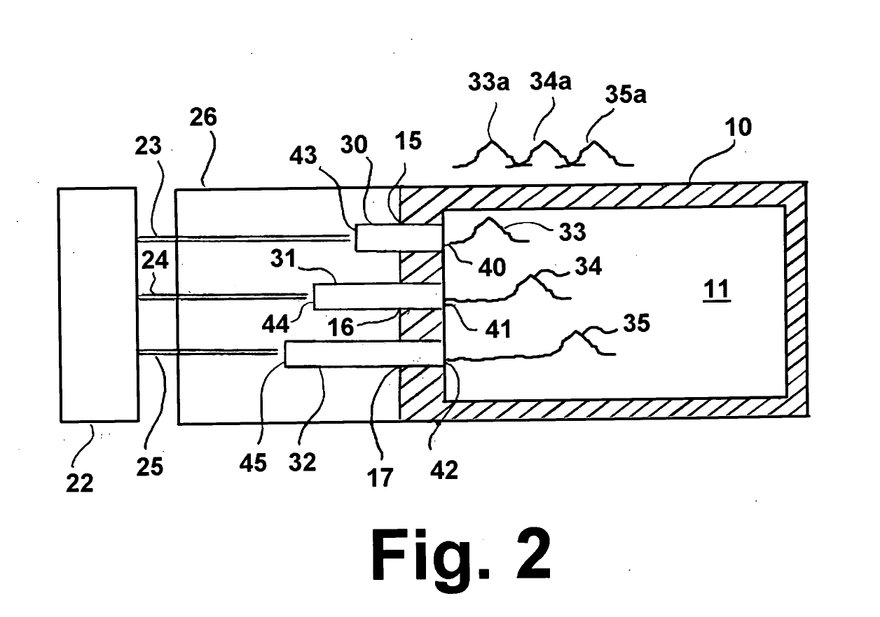

In contrast thereto, FIG. 2 schematically illustrates the scenario for a combustion system in the form of a single, multi-port burner in accordance with one embodiment of this invention. As shown therein, the combustion system comprises burner nozzles 30, 31, and 32 having different internal dimensions and having a fuel/oxidant inlet 43, 44, and 45, respectively, disposed distal from combustion chamber 11, and having fuel/oxidant mixture outlets 40, 41, and 42 disposed proximate combustion chamber 11. By virtue of the differences in the internal dimensions of the burner nozzles, the time required for each burner nozzle to respond to a pressure disturbance in the combustion chamber varies, producing non-uniform disturbance response times resulting in heat release patterns having the timing evidenced by peaks 33, 34, and 35. Due to the non-uniformity in disturbance response times, a single large heat release peak is avoided and replaced with multiple small peaks 33a, 34a, and 35a. Thus, the effect of multiple response times is to maintain a substantially uniform heat release pattern in the combustion chamber resulting from the pressure disturbance in the combustion chamber. Burner nozzles may also have different outlet sizes to provide different volumetric flow rates.

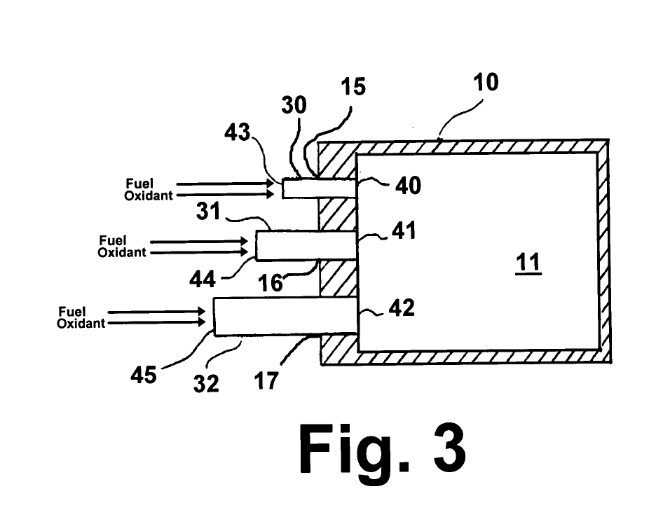

FIG. 3 shows a combustion system in accordance with one embodiment of this invention comprising a combustion chamber wall 10 enclosing a combustion chamber or space 11 and forming a plurality of burner nozzle openings 15, 16, and 17 in which are disposed burner nozzles 30, 31, and 32, respectively. Burner nozzles 30, 31, and 32 are oriented with fuel/oxidant outlets 40, 41, and 42 proximate combustion chamber 11 and fuel/oxidant inlets 43, 44, and 45 distal from combustion chamber 11. Fuel and oxidant are provided to each burner nozzle wherein the fuel and oxidant are mixed, forming a fuel/oxidant mixture. As shown in FIG. 3, each of burner nozzles 30, 31, and 32 have different internal dimensions (volumes), with burner nozzle 30 shown as having the smallest internal dimensions, burner nozzle 32 having the largest internal dimensions, and burner nozzles 31 having intermediate internal dimensions with respect to the internal dimensions of burner nozzles 30 and 32. The burner nozzles may also have different fuel/oxidant outlet sizes so that different volume flow rates (Q) may be utilized to affect the response time.

The method of this invention comprises positioning a burner nozzle in each of a plurality of burner nozzle openings formed by at least one wall of a combustion chamber where at least a portion of the burner nozzles have different internal dimensions from others of the burner nozzles. A fuel and oxidant are introduced into each of the burner nozzles resulting in a fuel/oxidant mixture within each of the burner nozzles, which mixture is ignited, resulting in combustion of the fuel/oxidant mixtures and production of a plurality of heat release patterns within the combustion chamber. In accordance with one embodiment of this invention, differences in fuel/oxidant delivery response times among the burner nozzles may further be enhanced by modifying the fuel/oxidant ratios of the mixtures.

While in the foregoing specification this invention has been described in relation to certain preferred embodiments thereof, and many details have been set forth for the purpose of illustration, it will be apparent to those skilled in the art that the invention is susceptible to additional embodiments and that certain of the details described herein can be varied considerably without departing from the basic principles of this invention.

We claim:

1. A combustion system comprising:
at least one wall enclosing a combustion chamber and forming a plurality of burner nozzle openings; and
a premix burner or burner nozzle disposed within each of said burner nozzle openings, each said premix burner or burner nozzle having a premixed fuel/oxidant outlet proximate said combustion chamber and a fuel/oxidant inlet distal from said combustion chamber, and at least a portion of said premix burners or burner nozzles sized to produce different fuel/oxidant delivery response times.

2. A combustion system in accordance with claim 1, wherein said fuel/oxidant inlets are in fluid communication with a common oxidant source.

3. A combustion system in accordance with claim 2, wherein said fuel/oxidant inlets are in fluid communication with a common fuel source.

4. A combustion system in accordance with claim 2, wherein said common oxidant source is an oxidant-containing plenum disposed around said fuel/oxidant inlets.

5. A combustion system in accordance with claim 4, wherein said common fuel source is a fuel-containing plenum.

6. A combustion system in accordance with claim 5 further comprising a plurality of fuel conduits in fluid communication with said fuel-containing plenum, each said fuel conduit having a fuel outlet positioned to deliver fuel from said fuel-containing plenum through said fuel/oxidant inlet of each said premix burner nozzle.

7. A combustion system in accordance with claim 1, wherein at least a portion of said premix burners or burner nozzles are internally dimensionally different.

8. A combustion system in accordance with claim 1, wherein at least a portion of said premixed fuel/oxidant outlets have different sizes.

9. A method for controlling combustion driven acoustic pulsations in a combustion system comprising the steps of:
positioning a burner or burner nozzle in each of a plurality of burner or burner nozzle openings formed by at least one wall of a combustion chamber, at least a portion of said burners or burner nozzles having internal dimensions different from other said burners or burner nozzles;
introducing a fuel and oxidant into each of said burners or burner nozzles resulting in a fuel/oxidant mixture within said burners or burner nozzles; and
igniting said fuel/oxidant mixtures, resulting in combustion of said fuel/oxidant mixtures and producing a plurality of phase-shifted heat release patterns within said combustion chamber.

10. A method in accordance with claim 9, wherein a fuel/oxidant ratio of at least one fuel/oxidant mixture within one of said plurality of burners or burner nozzles is different from another fuel/oxidant ratio of another said fuel/oxidant mixture within another of said plurality of burners or burner nozzles.

11. A method in accordance with claim 9, wherein a volume flow rate of said fuel/oxidant mixture through at least one of said plurality of burners or burner nozzles is different from another volume flow rate through another of said plurality of burners or burner nozzles.

12. A method in accordance with claim 9, wherein a fuel/oxidant ratio of said fuel/air mixture in at least one of said plurality of burners or burner nozzles is fuel rich.

13. A method in accordance with claim 9, wherein said fuel is provided to said plurality of burner nozzles from a common fuel source.

14. A method in accordance with claim 9, wherein said oxidant is provided to said plurality of burner nozzles from a common oxidant supply.

15. A method in accordance with claim 9, wherein said oxidant is air.
